(19) United States
(12) Patent Application Publication
(10) Pub. No.: US 2014/0154365 A1
(43) Pub. Date: Jun. 5, 2014

(54) CRISPING COMPOSITIONS AND PROCESSES FOR PREPARING CRISP, NON-PARFRIED, NON-FRIED DUSTED VEGETABLE PRODUCTS WITH ENHANCED CRISPNESS AND HAVING NO ADDED FAT

(71) Applicants: John F. Stevens, Grand Rapids, MI (US); Cheree L.B. Stevens, Grand Rapids, MI (US); Naomi Muhlberg, Grand Rapids, MI (US)

(72) Inventors: John F. Stevens, Grand Rapids, MI (US); Cheree L.B. Stevens, Grand Rapids, MI (US); Naomi Muhlberg, Grand Rapids, MI (US)

(21) Appl. No.: 14/093,864

(22) Filed: Dec. 2, 2013

Related U.S. Application Data
(60) Provisional application No. 61/731,798, filed on Nov. 30, 2012.

(51) Int. Cl. A23L 1/00; A23L 1/217; A23L 1/214

(52) U.S. Cl. CPC A23L 1/005; A23L 1/2142; A23L 1/217
USPC 426/96; 426/296

(57) ABSTRACT

A method for producing a non-fried, and non-parfried dusted vegetable product that is therefore essentially devoid of any added fat constituting a “no fat” food label claim product with increased crispness that includes the following steps: providing a whole vegetable; cutting the whole vegetable into a plurality of vegetable substrates; contacting the plurality of vegetable substrates with water or a water-containing solution to form enriched vegetable substrates; dusting the water enriched vegetable substrates with a dry crispness enhancing composition configured to be dusted onto the surface of the water enriched vegetable substrates to form dusted vegetable substrates where the dry crispness enhancing composition includes an adhesion component and a texture enhancing component, pre-baking the dusted vegetable substrates in an oven to gelatinize the adhesion component onto the substrate surface while simultaneously cementing the particulates of the texture enhancing component within the adhesion component, and then freezing the product.

### CROSS-REFERENCE TO RELATED APPLICATION

This application claims priority to and the benefit of Provisional Patent Application Ser. No. 61/731,798, filed on Nov. 30, 2012, entitled CRISPING COMPOSITIONS AND PROCESSES FOR PREPARING CRISP, NON-PARFRIED, NON-FRIED DUSTED VEGETABLE PRODUCTS WITH ENHANCED CRISPNESS AND HAVING NO ADDED FAT, the entire disclosure of which is hereby incorporated by reference.

### BACKGROUND OF THE INVENTION

Coated vegetable substrate segments (in particular a french fry or potato wedge or other potato segment) are known to have wet batter coatings applied to the surface of the vegetable substrate segment that are parfried during their initial production and prior to freezing and shipment to be finish fried and thereafter consumed.

Such coated french fries are typically made by the following process, which is generally described in FIG. 1. First, potatoes are obtained. The most commonly used potato varieties in the United States are Russets. Thereafter, the potatoes are washed, optionally peeled, sorted, and cut. Thereafter, the french fries are typically blanched. Blanching is usually done using a screw blancher. The time and temperature of blanching is adjusted in order to inactivate enzymes, remove excess sugars and give the potato slices a consistent and uniform color. After blanching, the potato substrates/strips are typically dipped in a solution of sodium acid pyrophosphate.

Next, the strips are typically partly dried and/or roasted to remove about 10% to 20% moisture inherent in the substrate. Once partially dried in a dryer, the french fry substrates are optionally coated with a clear-coat type batter composition (substantially invisible to the naked eye/consumer after frying and at the time of consumption) or other wet batter coating may be applied so that the manufacturer is then able to freeze the individually batter coated potato pieces without them all clumping together, especially during subsequent freeze-thaw cycles during transport and storage where internal product temperature rises above freezing and returns to a frozen state. Thereafter, the wet batter coatings are typically set using a fryer by parfrying or partially frying the coated strips, which is typically done at the manufacturing facility before being then frozen and transported to be finish fried by the purchaser/restaurant/distributer/supermarkets or the end consumer. This par-fry step sets the coating on the potato strip of the fry. Thereafter, the par-fried french fries are packaged and frozen for shipment to their final destination. At the final destination, typically distributors, restaurants, and/or supermarkets, where they are finished fried or baked by or for the consumer. Additionally, it is known to parfry and finish fry or finish bake an uncoated french fry. As would be apparent from the above processes, in order to obtain a crisp, coated or uncoated product, heretofore the processor typically had to go through a parfrying or frying step to set the coating on the individual potato pieces for the reasons stated previously. In addition to the cost of the oil itself, the parfrying of a product requires significant factory/production space within a facility and large amounts of power and energy to be provided to heat the oil in the process. As a result, parfrying adds to the overall cost and time to produce product. Additionally, often such parfried and frozen products are finish fried at the consumer level. Each frying step typically adds overall fat to any potato substrate and the amount of that fat is stated on the Nutrition Information panel of product labels in the United States.

### BRIEF SUMMARY OF THE INVENTION

One aspect of the present invention is generally directed toward a method of producing a non-fried and non-parfried dusted vegetable product with increased crispness that includes the following steps: providing a whole vegetable; cutting the whole vegetable into a plurality of vegetable substrates; contacting the plurality of vegetable substrates with water or a water-containing solution such that the plurality of vegetable substrates pick up some amount of water or water solution to about 15% by weight of the plurality of vegetable substrates, more typically from about 1% to about 15% by weight of the plurality of vegetable substrate, and more typically from about 3% to 12% water or water solution by weight of the plurality of vegetable substrates to form (water) enriched vegetable substrates usually without any blanching of the water enriched vegetable substrates; dusting the (water) enriched vegetable substrates with a dry crispness enhancing composition configured to be dusted onto a surface of the (water) enriched vegetable substrates to form dusted vegetable substrates where the dry crispness enhancing composition includes an adhesion component that is a pregelatinized potato starch and a texture enhancing component that is typically a dry particulate, such as a dry corn component, typically a dry corn particulate. The dry corn component is typically chosen from a cornmeal, a corn grit, and mixtures thereof; and pre-baking the dusted vegetable substrates in an oven to form crispness enhanced, dusted, pre-baked vegetable substrates.

Another aspect of the present invention is generally directed toward a method of producing a non-fried and non-parfried dusted vegetable product that includes the steps of: providing a whole food substrate that is a whole vegetable; cutting the whole vegetable into a plurality of vegetable substrates; contacting the plurality of vegetable substrates with potable water such as: tap water; distilled water; filtered water; deionized water and/or the like, such that the plurality of vegetable substrates pick up at least about 1%, and more typically at least about 3% water by weight of the plurality of vegetable substrates to form water-enriched vegetable substrates; dusting the water-enriched vegetable substrates with a dry crispness enhancing composition configured to be dusted onto a surface of the water-enriched vegetable substrates to form dusted vegetable substrates wherein the dry crispness enhancing composition comprises an adhesion component that includes a pregelatinized potato starch and a typically dry crisping particulate that is typically a dry corn component that is chosen from: a corn meal; a corn grit; and mixtures thereof; and baking the dusted vegetable substrates in an oven to form baked vegetable substrates before then freezing.

Yet another aspect of the present invention is generally directed toward a no added fat, non-parfried, no n-fried vegetable substrate comprising: a par-baked, but prior to par-baking, water-enriched (and typically unblanched) vegetable substrate that is a portion of a whole vegetable that has a coating composition comprising a dry particulate component that is typically corn component chosen from the group consisting of a corn grit, a corn meal, or a mixture thereof that is adhered to the vegetable substrate prior to par-baking of the vegetable substrate by application of an adhesion composition that comprises a pregelatinized potato starch.

The par-baking is carried out long enough and at a temperature that is high enough to (1) inactivate naturally occurring vegetable enzymes that would otherwise develop undesirable coloring termed “enzymatic browning,” and (2) allow the dry crispness enhancing composition to bond substantially with the substrate's surface.

These and other features, advantages, and objects of the present invention will be further understood and appreciated by those skilled in the art by reference to the following specification, claims, and appended drawings.

### BRIEF DESCRIPTION OF THE DRAWING

FIG. 1 is a flowchart of a process according to an embodiment of the present invention.

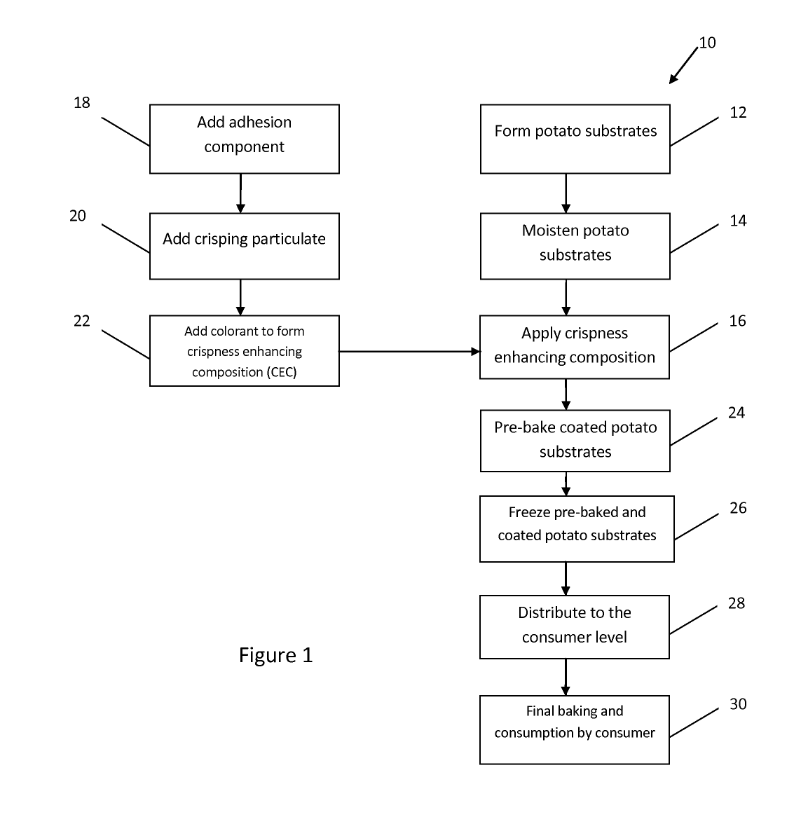

### DETAILED DESCRIPTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. In this specification and the appended claims, the singular forms “a,” “an” and “the” include plural reference unless the context clearly dictates otherwise.

The present invention generally relates to compositions and processes for adhering a dry (typically moisture/liquid/water on an “as is” basis or a “moisture free” basis or anything there between) crispness enhancing composition to a vegetable substrate's outer surface, typically a potato substrate, more typically a shoestring french fry, straight cut french fry, crinkle cut french fry, potato chunk, potato wedge, or any other french fry or potato substrate of any size or dimension other than a whole potato to whole vegetable using a dry dusted adhesion composition without a frying step of any kind, parfrying or finish frying in particular to adhere the dry crispness enhancing composition. The cut of the potato substrate may be of any type for purpose of the present invention including potato chunks, crinkle cut, shoe-string cut, and straight cut french fries. The vegetable substrates can be sliced or whole and could be a blend of different vegetable substrates. Additionally, the present invention generally relates to the formation of one such dusted potato substrate without a parfrying or frying step of any kind being used and where the dry crispness enhancing composition is not a wet batter coating on the vegetable (potato) substrate. As a result, the dusted, enhanced crispness products have no added fat beyond any naturally occurring fat in the dusting composition's ingredients and the raw vegetable product which would be considered “minimal” as the total fat in the finish fry is less than 0.5 g per labeled serving of the total finish fry, allowing the product's Nutrition Information Panel to state “0% fat.”

In the case of the present invention, the vegetable (potato) substrates, including sweet potatoes (for purposes of this application, sweet potato include yams and sweet potatoes), are typically sorted and thereafter cut. The vegetable (potato) substrates are preferably not blanched. The cut vegetable (potato) pieces are typically next subjected to a water spray or subjected to water dipping in water at any temperature above freezing, and below boiling but is typically at a temperature from about 100° F. to 120° F. The elevated temperature above ambient (65-75° F.) temperature improves the water binding to the substrate and allowing for from about 3% to 12% water pick up, more typically from about 5% to about 8% water pick up by weight of the vegetable substrate. When sweet potatoes are used, the vegetable substrates are typically sprayed due to the fiber of the sweet potato substrates' ability to quickly absorb and pick up water whereas white-fleshed potatoes are typically able to be dipped in the water, which is typically heated.

The water described above is potable water such as tap water, distilled water, filtered water and/or the like. In addition to using water (free of any solutes or any other additives), water solutions can also be employed so long as water is picked up by the vegetable substrate and water solutions containing one or more solutes such as sugars and salts can also be used. The water addition step is necessary as it provides the vehicle by which the dry crispness enhancing composition will adhere to the vegetable substrate. The vegetable substrates of the present disclosure are not dried immediately prior to application of the crispness enhancing composition.

The water enriched vegetable (potato) substrates are next dusted with a dry crispness enhancing composition that includes a dry dusting adhesion component and a crisping particulate such as a corn component. The present invention typically involves applying an amount of a specific dry crispness enhancing composition to the surface of the water enriched vegetable (potato) substrate.

The dry crispness enhancing composition typically includes an adhesion component and a texture enhancing component. The dry adhesion component is typically present in an amount of up to about 65% to about 85%, more typically about 75% by weight of the dry crispness enhancing composition. The texture enhancing component, typically a corn component, is typically present in an amount of from about 20% to about 30% and more typically about 25% by weight of the dry crispness enhancing composition. The dry crispness enhancing composition may also optionally contain flavorings, seasonings, salt, and colorants. When added these components typically are present in an amount of from about 0% to about 5% by weight of the dry crispness enhancing composition and more typically 0.5% to 2% by weight of the dry crispness enhancing composition. The dry crispness enhancing composition is applied to the surface in one of many manners known in the industry to apply dry dust coatings to substrates such as the use of breading equipment and/or tumbler equipment. The dry crispness enhancing composition is applied to the vegetable substrate in an amount typically from about 1% to about 14%, more typically about 4% to about 10% (by weight of the substrate before coating).

Surprisingly, the only dry dusting adhesion component applicants have discovered that hydrates sufficiently quickly such that it will “adhere,” “cement,” or “glue” the crisping particulates, such as corn particulates to the vegetable substrate(s) during a pre-baking step without a frying processing setting step such as frying or parfrying to set the dry crispness enhancing composition and adhere the corn particulates to the substrate(s) while also adding the improved functionality of added crispness to the potato substrate is a pregelatinized potato starch. The pregelatinized potato starch is more typically a cross-linked and pregelled/pregelatinized potato starch. Applicants presently believe such cross-linked and pregelled/pregelatinized potato starch preferably will also not have any other chemical or physical modifications. A mixture of uncross-linked and cross-linked pregelatinized potato starch or an uncrosslinked and pregelatinized potato starch may also optionally be used to provide the above adhesion and added crispness. Applicants have discovered that a cross-linked, acetylated pregelatinized potato starch will also add crispness to the final product while adhering the corn components. Applicants have discovered that use of other than pregelatinized starch and more specifically use of other than a pregelatinized potato starch significantly deteriorate the functionality of adhering the corn particulates to the substrate in the context of the present invention.

Of all the various starches and fibers tested thus far, only the use of pregelatinized potato starches, in particular, pregelatinized and cross-linked potato starches provides both the functionality of adhering the corn particulates while also adding the enhanced crispness to the final product that is typically desired in such dusted vegetable/potato substrates and not altering the color of the product significantly or at all. If a pregelatinized potato starch is not utilized, applicants have not been able to successfully adhere the corn particulates to the vegetable (potato) substrate(s). Without this adhesion, the texture enhancing component (corn particulates) will not adhere to the substrates and the vegetable substrates will not exhibit enhanced crispness.

The corn particulates of the dry crispness enhancing composition are typically white or yellow degermed corn grit or cornmeal or a combination thereof. Applicants presently believe that different manufacturers use the terms corn grits and corn meal to denote the same raw material. The white corn grit or white corn meal has been found to be preferable when the dry crispness enhancing composition is applied to white potato substrates to avoid visibility of the dust and make the dust invisible to the human eye of an average consumer. Similarly, yellow corn meal and yellow corn grits are preferably used in connection with coatings for sweet potatoes for the same reasons. Such corn particulates are less visible on the sweet potato substrates making the dry crispness enhancing composition on dusted substrates invisible to the human eye of an average consumer immediately prior to consumption. Particularly preferred corn components include: degermed yellow cornmeal CCM 250 and CCM 255 and degermed white corn meal WCCM 254 and 250 from BUNGIE Milling, Inc. of St. Louis, Mo. 63246. Blends of components can be used. The corn particulates are typically sized to allow at least about 60% of the particles to be on and not pass through a US 70 mesh size screen (about 0.21 mm). The corn particulates can be a blend of particulates. The particle size of the corn particulates cannot be too small or too large. If they are too large they become visible and if too small they do not add sufficient crispness to the finished, dusted vegetable substrates.

Applicants presently believe that the particle size of the CCM 250 corn component of the dry crispness enhancing composition(s) of the present invention should have a particle size such that a maximum of 0.1% of the particles sit on a US 16 Mesh screen, a maximum of 2.0% of the particles sit on a 20 US Mesh screen, a maximum of 18.0% of the particles sit on a 25 US Mesh screen, a minimum of 30% and a maximum of 50% sit on a 30 US Mesh screen, a minimum of 35% and a maximum of 55% sit on a 40 US Mesh screen, a maximum of 8.0% sits on a 50 US Mesh screen and a maximum of 2.0% passes through a 50 US Mesh screen.

Applicants presently believe that the particle size of the CCM 255 corn component of the dry crispness enhancing composition(s) of the present invention should have a particle size such that a maximum of 0.1% of the particles sit on a US 16 Mesh screen, a minimum of 25% and a maximum of 45% sit on a 30 US Mesh screen, a minimum of 35% and a maximum of 60% sit on a 40 US Mesh screen, a minimum of 5.0% sits on a 60 US Mesh size screen and a maximum of 25.0% sits on a 60 US Mesh screen and a maximum of 4.0% passes through a 60 US Mesh screen.

Applicants presently believe that the particle size of the WCCM 254 white corn meal component of the dry crispness enhancing composition(s) of the present invention should have a particle size such that a maximum of 1% of the particles sit on a US 20 Mesh screen, a maximum of 20% of the particles sit on a 30 US Mesh screen, a minimum of 60% and a maximum of 90% sit on a 70 US Mesh screen, a maximum of 20% passes through a 70 US Mesh screen.

Applicants presently believe that the particle size of the WCCM 250 corn component of the dry crispness enhancing composition(s) of the present invention should have a particle size such that a maximum of 0.1% of the particles sit on a US 16 Mesh screen, a maximum of 2.0% of the particles sit on a 20 US Mesh screen, a minimum of 4.0% and a maximum of 18.0% of the particles sit on a 25 US Mesh screen, a minimum of 30% and a maximum of 50% sit on a 30 US Mesh screen, a minimum of 35% and a maximum of 55% sit on a 40 US Mesh screen, a maximum of 8.0% sits on a 50 US Mesh screen and a maximum of 2.0% passes through a 50 US Mesh screen.

The dry crispness enhancing composition(s) of the present invention are not typically breading compositions, which typically have significantly higher particles sizes than those of the set dusting compositions of the present invention.

It has been surprisingly discovered that dry dusting adhesion component, typically a pregelatinized, cross-linked potato starch, as discussed above, hydrates rapidly and forms transparent cement that adheres the corn component to the surface of the substrate when both are applied. Both are typically applied in one composition during the same step as discussed herein, but conceivably and while not preferred could potentially be applied in successive steps carried out in succession.

The dry crispness enhancing composition(s) may also optionally, as discussed previously, contain a coloring ingredient such as oleoresin paprika, which is typically applied to sweet potatoes to further limit or eliminate visibility of the dry dusting blend/composition on the finished vegetable substrate. Other coloring ingredients that may be used in the dry crispness enhancing composition(s) include: dextrose, caramel color, whey or any combination thereof. These components or combination of components are typically used when white-fleshed potatoes are being dusted to further limit or eliminate visibility of the dry crispness enhancing composition(s).

Salt (sodium chloride), flavorings (something that adds an agreeable or interesting taste to the finished, dusted vegetable substrates), and seasonings (something that adds an agreeable or interesting taste to food or something that enhances the flavor of the finished, dusted vegetable substrates). The dry crispness enhancing composition(s) of the present disclosure should not utilize and should be free from any gelatin, gelatin-like component, any pectin, and/or any gums such as xanthan gum or any other gum component as these cause the finished product surface to become commercially unacceptable because the surface becomes sticky, chewy, and/or gummy in mouth feel.

The typical process of the present disclosure 10 begins with forming potato substrates 12 from whole potatoes by cutting the whole potatoes. The potato substrates are then moistened with water 14. Once moistened, the dry crispness enhancing composition is applied to the moistened surface of the potato substrate 16. All of the components of the dry crispness enhancing composition are typically blended into a homogenous blend by adding the adhesion component (pregelled starch) to a mixing vessel 18, adding the crisping particulate 20, and thereafter other optional ingredients such as colorants, salt and/or flavorings 22 to form the crispness enhancing composition.

Typically from about 1% (or 1%) by weight of the uncoated substrate to about 14% (or 14%) by weight of the uncoated substrate, more typically from about 4% (or 4%) by weight of the uncoated substrate and most typically about 10% (or 10%) by weight of the uncoated substrate of the crispness enhancing composition is applied using one or more dry ingredient applicators known to those in the industry of applying dry coatings to substrates. In a much less preferred embodiment, the adhesion component can be applied to the moistened vegetable substrate and immediately thereafter the crisping particulate applied. If two immediately successive steps are used, there typically should be higher amounts of water added to the surface of the vegetable substrate to ensure there is enough water to bind the crisping particulate and the adhesion component. As discussed herein, it is significantly more preferred to apply the adhesion component and the crisping particulates and any other component of the crisping enhancing composition as a homogenous blend to the moistened vegetable substrate to ensure that the components hydrate enough to adhere to the substrate until the pre-baking step occurs, which chemically bonds or glues the components to the substrates.

Next, the dusted vegetable substrates are pre-baked 24 also known as parbaked, in an oven to form dusted, baked vegetable substrates. This pre-baking or parbaking is done shortly after the dry crispness enhancing composition is applied to the water enhanced vegetable substrate, typically within about 30 minutes. The pre-baking step is typically done at the processor to “set” the particulate immovably onto the substrate by the adhesion component gelatinizing at the substrate surface while simultaneously trapping the crisping (corn) particulates within the adhesion component. Pre-baking is done at temperatures of about 300° F. to 500° F. for from about 5 to about 20 minutes or more typically at a temperature of from about 400° F. to about 450° F. for from about 5 minutes to about 15 minutes, most typically for about 9 minutes at a temperature of about 425° F. Following the pre-baking step the dusted product is able to be transported to the freezer for solid freezing before shipping them to the marketplace (consumer level) 28 without marriage or clumping of the pieces. The process can be done as a continuous process or as a batch process.

As discussed above, after the prebaking steps, the potato products are then packaged and are typically refrigerated or frozen, more typically frozen and transported to a distributor, who ultimately delivers the packaged product to retail grocery stores for sale directly to the individual consumer or for use by a commercial establishment to offer to its customers. The finishing step 30 for the preparation of the product for consumption does not require a frying step either and are typically reconstituted in an oven such as a household kitchen oven or commercial oven. The baking oven may be either a conventional gradient oven or a convection oven. The frozen vegetable substrates are typically baked in a conventional gradient oven for about 20 minutes at a temperature of from about 425 to 450 degrees Fahrenheit while typically, but optionally, turning the substrate 180 degrees in both the horizontal (X-Y) and vertical (X-Z or Y-Z) planes after about 10 minutes of the total about 20 minutes has past. When the oven is the convection oven, the frozen vegetable substrates are baked for about 14 minutes at a temperature of from about 425 to 450 degrees Fahrenheit while typically, but optionally turning the substrate 180 degrees in both the horizontal (X-Y) and vertical (X-Z or Y-Z) planes after about 7 minutes of the total about 14 minutes has past when the oven is the convection oven. The baked product has the same or substantially the same appearance and texture as products manufactured using a parfrying process to set a wet batter at a manufacturing facility. The baked product no longer tastes like a baked fry, but tastes and has the texture similar to a product that has been finished fried in a fryer.

As discussed above, the products of the present invention have significantly less fat content than wet batter coated products that use a parfrying step to set the wet batter composition, a process previously widely believed by the industry to be necessary to set the wet batter composition prior to freezing. Since the parfrying step has been eliminated, the accompanying fat uptake from that portion of the process has also been eliminated. The products of the present invention have zero added fat due to a frying or parfrying step and typically have only the fat naturally occurring in the substrate and coating/blend components, which is typically less than about 0.5% by weight of the finished product prior to consumption. The products of the present invention meet the 21 CFR §101.62 label claim on the nutrition label of a “no fat” product. The products of the present disclosure contain less than 0.5 gram (g) of fat per reference amount customarily consumed and per serving labeled. 21 CFR §101.62 is hereby incorporated by reference in its entirety. That section produces that the terms “fat free,” “free of fat,” “no fat,” “zero fat,” “without fat,” “negligible source of fat,” or “dietarily insignificant source of fat” or, in the case of milk products, “skim” may be used on the label or in labeling of foods, provided that:
(i) The food contains less than 0.5 gram (g) of fat per reference amount customarily consumed and per labeled serving or, in the case of a meal product or main dish product, less than 0.5 g of fat per labeled serving; and
(ii) The food contains no added ingredient that is a fat or is generally understood by consumers to contain fat unless the listing of the ingredient in the ingredient statement is followed by an asterisk that refers to the statement below the list of ingredients, which states “adds a trivial amount of fat,” “adds a negligible amount of fat,” or “adds a drearily insignificant amount of fat;” and
(iii) As required in 101.13(e)(2), if the food meets these conditions without the benefit of special processing, alteration, formulation, or reformulation to lower fat content, it is labeled to disclose that fat is not usually present in the food (e.g., “broccoli, a fat free food”).

It is to be understood that variations and modifications can be made on the aforementioned structure without departing from the concepts of the present invention, and further it is to be understood that such concepts are intended to be covered by the following claims unless these claims by their language expressly state otherwise.

### EXAMPLES

All Examples discussed below are laboratory scale examples of various aspects of the present invention.

### Example 1

TABLE 1

| | Formulas | | | |
|---|---|---|---|---|
| | Example 1: Formula | Example 2: Formula | Example 3 = | Example 4 = Control |
| | with White Corn Grits; | with White Corn | Example 1 WITH | 2 WITH Dextrose |
| | NO Dextrose Dip - just | Grits; NO Dextrose | Dextrose and Water | and Water Solution |
| | Water Dip | Dip - just Water Dip | Solution Dip | Dip |
| | DESCRIPTION | | | |
| | % by weight of the | % by weight of the | % by weight of the | % by weight of the |
| | dry crispness | dry crispness | dry crispness | dry crispness |
| | enhancing | enhancing | enhancing | enhancing |
| | composition | composition | composition | composition |
| White Corn Grits, −20/ | 25.000 | 0.000 | 25.000 | 0.000 |
| +30 Fraction | | | | |
| White Corn Grits, −30/ | 0.000 | 25.000 | 0.000 | 25.000 |
| +50 Fraction | | | | |
| Adhesion Dust | 74.500 | 74.500 | 74.500 | 74.500 |
| Composition | | | | |
| Fried Flavor | 0.500 | 0.500 | 0.500 | 0.500 |
| FORMULA PERCENT | 100.000 | 100.000 | 100.000 | 100.000 |
| TOTAL: | | | | |

Method:
1. Prepare sizes needed for corn grits/meal using sieves or Hamilton Beach™ Grinder on Espresso™ (fine)/“cup” 15;
2. Mixing the dry ingredients:
   a. Place the needed corn grits/meal into 5 qt. Kitchen Aid™ bowl.
   b. Add all of the needed adhesion dust to a.) above.
   c. Add all of the needed flavor to the mixture of a.) and b.) above.
   d. Mix (by hand using a rubber spatula) until a uniform blend is achieved.
3. Dust the potato:
a. Make ⅜″potato straight cuts from fresh “white” potato using 21% Solids Russet Potatoes.

For Examples 1 and 2, a cut potato substrate (for example, ⅜″ potato straight cuts) are held in cold water until needed, and the process proceeds to step c. For Examples 3 and 4, continue to step (3)(b).
b. Dip 100 g cut potato substrates in 2% Dextrose water solution (40 g Dextrose +1960 g 70° F. H₂O) for 20 seconds, then transfer to clean, dry bowls and hold there until needed.
c. Spread the dry crispness enhancing composition over three paper towel segments equaling 18″×11″ on long side.
d. Place four cut potato pieces in the dry crispness enhancing composition and roll until coated to meet target pick-up desired (about 6-7.5%).
e. Place dusted fries in sieve that is over a 5 qt. Kitchen Aid™ bowl and lightly shake without tapping.
f. Place dusted fries onto 18″×10″ wire rack then place onto 18″×12″ metal tray.
g. Bake in preheated 425° F. retail convection oven for 9 minutes.
4. Freeze singulated in a freezer (−20° F. to −10° F.) until frozen on perforated aluminum trays.
5. Once frozen, pack the fries into a moisture-barrier bag and seal the bag(s).
6. Move bagged frozen product to storage freezer (−10° F. to +10° F.) and hold at least 48 hours before reconstituting.

### Reconstitution (Baked):

### Primary: Gradient Oven:

Bake about one pound of the frozen, dusted potato substrates single-layered on a greased (Teflon™) polytetrafluroethylene coated baking sheet in a preheated 425° F.-450° F. (preferably 450° F.) gradient oven for 20 minutes. Typically, fries are turned and the tray rotated halfway through the baking cycle, if possible.

### Secondary: Convection Oven:

Bake about one pound of the frozen, dusted potato substrates single-layered on a greased (Teflon™) polytetrafluroethylene coated baking sheet in a preheated 425° F. 450° F. (preferably 450° F.) convection oven for 14 minutes, typically, halfway through the baking cycle.

TABLE 2

| | Example 5 | Example 6 |
|---|---|---|
| | DESCRIPTION | |
| | % by | % be |
| | weight of the dry | weight of the dry |
| | crispness enhancing | crispness enhancing |
| | composition | composition |
| Texture Enhancing | | |
| Component Corn Grits | | |
| (Degerminated, Yellow): | | |
| Corn Grits −20/+30 Fraction | 25.15 | 0.00 |
| Corn Grits −30/+50 Fraction | 0.00 | 25.15 |
| Adhesion Component | 74.25 | 74.25 |
| Oleoresin Paprika | 0.60 | 0.60 |
| FORMULA PERCENT | 100.00 | 100.00 |
| TOTAL: | | |

TABLE 2a

| | Example 7 | Example 8 |
|---|---|---|
| | DESCRIPTION | |
| | % by | % by |
| | weight of the dry | weight of the dry |
| | crispness enhancing | crispness enhancing |
| | composition | composition |
| Adhesion Component | 74.250 | 74.250 |
| Oleoresin Paprika | 0.600 | 0.600 |
| Degermed Yellow Corn Meal | 25.150 | |
| Degermed Yellow Corn Meal | | 25.150 |
| FORMULA PERCENT | 100.000 | 100.000 |
| TOTAL: | | |

Method:
1. Add the adhesion component to mortar.
2. Mix in corn grits/meal (texture enhancing component) using rubber spatula until uniform.
   Prepare sizes needed for corn grits/meal using sieves or Hamilton Beach™ Grinder on Espresso™ (fine)/“cut” 15.
3. Add the needed amount of colorant until uniform colored mix is obtained.
4. Make ⅜″ Potato straight cuts from Fresh Sweet Potato, making sure to peel back past the yellow fibers.
5. Dip cut Sweet Potato into 100-120° F. water housing a sieve for 10-12 seconds, removing the potato from the water by lifting the sieve containing the potato (Target water pick up=5-8%).
6. Spread dry crispness enhancing composition on paper towel segments.
7. Place cut sweet potatoes from step 5 in the dry crispness enhancing composition, rolling until evenly dusted to meet pick up (about 6-7.5%).
8. Place evenly dusted fries in sieve that is over a 5 qt. Kitchen Aid™ bowl and lightly shake without tapping to remove excess dust, which can then be reused.
9. Place dusted fries onto wire rack and then place onto perforated metal trays.
10. Bake in preheated 425° F. retail convection oven for 9 minutes.

TABLE 3

| | Water-Dipping the Potato | | | | | |
|---|---|---|---|---|---|---|
| | Example 5 | | | Example 6 | | |
| | Test 1 | Test 2 | Test 3 | Test 1 | Test 2 | Test 3 |
| Uncoated Potato Wt (g) | 7.8 | 8.0 | 8.6 | 7.4 | 8.3 | 9.4 |
| Water Coated Potato | 8.3 | 8.5 | 9.1 | 7.8 | 8.8 | 10.0 |
| Weight (g) | | | | | | |
| Coated − Uncoated Wt | 0.5 | 0.5 | 0.5 | 0.4 | 0.5 | 0.6 |
| Difference (g) | | | | | | |
| Minus the Wt Water left | 0.0 | 0.0 | 0.0 | 0.0 | 0.0 | 0.0 |
| on tray (g) | | | | | | |
| = Actual Wt Water | 0.5 | 0.5 | 0.5 | 0.4 | 0.5 | 0.6 |
| Picked up (g) | | | | | | |
| % Water Pick Up* | 6.4 | 5.6 | 5.6 | 5.8 | 5.9 | 6.1 |

| | | |
|---|---|---|
| Ave % Water Pick Up* | 5.9 | 5.9 |

$\text{*} \% Water Pick Up Calculation = \frac{Actual Water Picked Up}{( Uncoated Wt )} \times 100$ Dip cut Sweet Potato into 100-120° F. water housing a sieve for 10-12 seconds, removing by lifting sieve containing the Potato (Target water pick up = 5-8%)

TABLE 3a

| | Water-Dipping the Potato | | | | | |
|---|---|---|---|---|---|---|
| | Example 7 | | | Example 8 | | |
| | Test 1 | Test 2 | Test 3 | Test 1 | Test 2 | Test 3 |
| Uncoated Potato Wt (g) | 9.7 | 9.0 | 10.9 | 9.9 | 8.2 | 8.3 |
| Water Coated Potato | 10.3 | 9.6 | 11.6 | 10.4 | 8.6 | 8.8 |
| Weight (g) | | | | | | |
| Coated − Uncoated Wt | 0.7 | 0.6 | 0.7 | 0.5 | 0.5 | 0.5 |
| Difference (g) | | | | | | |
| Minus the Wt Water left | 0.0 | 0.0 | 0.0 | 0.0 | 0.0 | 0.0 |
| on tray (g) | | | | | | |
| = Actual Wt Water | 0.7 | 0.6 | 0.7 | 0.5 | 0.5 | 0.5 |
| Picked up (g) | | | | | | |
| % Water Pick Up* | 6.8 | 6.5 | 6.4 | 5.2 | 5.5 | 6.3 |

| | | |
|---|---|---|
| Ave % Water Pick Up* | 6.6 | 5.7 |

$\% Water Pick Up Calculation = \frac{Actual Water Picked Up}{( Uncoated Wt )} \times 100$ Dip cut Sweet Potato into 100-120° F. water housing a sieve for 10-12 seconds, removing by lifting sieve containing the Potato (Target water pick up = 5-8%)

TABLE 4

| | Dry Coating Pickup | | | | | |
|---|---|---|---|---|---|---|
| | Example 5 | | | Example 6 | | |
| | Test 1 | Test 2 | Test 3 | Test 1 | Test 2 | Test 3 |
| Uncoated Potato Wt (g) | 8.3 | 8.5 | 9.1 | 7.8 | 8.8 | 10.0 |
| Coated Potato Weight (g) | 8.8 | 9.0 | 9.7 | 8.3 | 9.4 | 10.5 |
| Coated − Uncoated Wt | 0.5 | 0.5 | 0.6 | 0.4 | 0.6 | 0.6 |
| Difference (g) | | | | | | |
| Minus the Wt Dry Coating | 0.0 | 0.0 | 0.0 | 0.0 | 0.0 | 0.0 |
| left on tray (g) | | | | | | |
| = Actual Wt Dry Coating | 0.5 | 0.5 | 0.6 | 0.4 | 0.6 | 0.6 |
| Picked up (g) | | | | | | |
| % Dry Coating Pick Up* | 6.4 | 6.4 | 6.7 | 5.6 | 7.2 | 5.7 |

| | | |
|---|---|---|
| Ave % Dry Coating Pick | 6.5 | 6.2 |
| Up* | | |

$\text{*} \% Dry Coating Pick Up Calculation \text{:} \frac{\begin{matrix}Actual Dry Coating \\ Picked Up\end{matrix}}{( Uncoated Wt )} \times 100$

TABLE 4a

| | Dry Coating Pickup | | | | | |
|---|---|---|---|---|---|---|
| | Example 7 | | | Example 8 | | |
| | Test 1 | Test 2 | Test 3 | Test 1 | Test 2 | Test 3 |
| Uncoated Potato Wt (g) | 10.3 | 9.6 | 11.6 | 10.4 | 8.6 | 8.8 |
| Coated Potato Weight (g) | 11.0 | 10.3 | 12.3 | 10.9 | 9.1 | 9.3 |
| Coated − Uncoated Wt | 0.7 | 0.6 | 0.7 | 0.6 | 0.5 | 0.5 |
| Difference (g) | | | | | | |
| Minus the Wt Dry Coating | 0.0 | 0.0 | 0.0 | 0.0 | 0.0 | 0.0 |
| left on tray (g) | | | | | | |
| = Actual Wt Dry Coating | 0.7 | 0.6 | 0.7 | 0.6 | 0.5 | 0.5 |
| Picked up (g) | | | | | | |
| % Dry Coating Pick Up* | 6.3 | 6.6 | 6.3 | 5.4 | 5.3 | 5.8 |

| | | |
|---|---|---|
| Ave % Dry Coating Pick | 6.4 | 5.5 |
| Up* | | |

$\text{*} \% Dry Coating Pick Up Calculation \text{:} \frac{\begin{matrix}Actual Dry Coating \\ Picked Up\end{matrix}}{( Uncoated Wt )} \times 100$

11. Freeze singulated in a freezer (−20° F. to −10° F.) until frozen on perforated aluminum trays.
12. Once frozen, pack fries into moisture-barrier bags and seal.
13. Move bagged frozen product to storage freezer (−10° F. to +10° F.) and hold at least 48 hours there before reconstituting.

1. A method of producing a non-fried and non-parfried vegetable product with increased crispness comprising the steps of:
providing a whole vegetable;
cutting the whole vegetable into a plurality of vegetable substrates;
contacting the plurality of vegetable substrates with water or a water-containing solution such that the plurality of vegetable substrates picks up about 3% to 12% water by weight of the plurality of vegetable substrates to form water enriched vegetable substrates;
dusting the water enriched vegetable substrates with a dry crispness enhancing composition configured to be dusted onto a surface of the water enriched vegetable substrates to form dusted vegetable substrates wherein the dry crispness enhancing composition comprises an adhesion component that is a pregelatinized potato starch and a corn particulate component that is chosen from the group consisting of: a cornmeal or corn grit and mixtures thereof and optionally a colorant; and
pre-baking the dusted vegetable substrates in a pre-baking oven to form prebaked vegetable substrates.

2. The method of claim 1, wherein the baked vegetable substrates are free of any added fat during processing from the whole vegetable into the pre-baked vegetable substrates and the vegetable substrates are not blanched at any time during the method.

3. The method of claim 2, wherein the dry crispness enhancing composition is free of any gelatin.

4. The method of claim 3, wherein the dry crispness enhancing composition is free of any gelatin, sucrose, and any component containing wheat gluten.

5. The method of claim 4, wherein the dry crispness enhancing composition is free of any component containing wheat and the dry crispness enhancing composition is free of any gelatin, pectin or gums.

6. The method of claim 5, wherein the method further comprises the steps of:
freezing the pre-baked vegetable substrates to form frozen vegetable substrates;
transporting the frozen vegetable substrates to a consumer located at a different location than where the pre-baked vegetable substrates are formed; and
final baking the frozen vegetable substrates in a final baking oven to form a reconstituted vegetable substrate.

7. The method of claim 6, wherein the final baking oven is chosen from the group consisting of a conventional gradient oven and a convection oven wherein the frozen vegetable substrates are baked for about 20 minutes at a temperature of from about 425 to 450 degrees Fahrenheit while turning the substrate 180 degrees in both the horizontal (X-Y) and vertical (X-Z or Y-Z) planes after about 10 minutes of the total about 20 minutes has past when the oven is the conventional gradient oven and wherein the frozen vegetable substrates are baked for about 14 minutes at a temperature of from about 425 to 450 degrees Fahrenheit while turning the substrate 180 degrees in both the horizontal (X-Y) and vertical (X-Z or Y-Z) planes after about 7 minutes of the total about 14 minutes has past when the oven is the convection oven;
wherein the vegetable substrates pick up from about 5 to about 8% water by weight of the vegetable substrates; and
wherein the step of cutting the whole vegetables comprising cutting the whole vegetables into a shape chosen from the group consisting of a cross-section and a wedge.

8. The method of claim 7, wherein the whole vegetable is a fresh sweet potato and, as a result, the plurality of vegetable substrates are a plurality of sweet potato substrates and the water-enriched vegetable substrates are water-enriched sweet potato substrates and wherein the corn component consists of yellow corn grits.

9. The method of claim 7, wherein the whole vegetable is a fresh white potato and, as a result, the plurality of vegetable substrates are a plurality of white potato substrates and the water-enriched vegetable substrates are water-enriched white potato substrates and wherein the corn component consists of white corn grits; and
wherein the dry crispness enhancing composition further comprises oleoresin paprika.

10. The method of claim 1, wherein the dry crispness enhancing composition further comprises a supplemental component chosen from the group consisting of dextrose, a caramel coloring, whey, and mixtures thereof.

11. The method of claim 1, wherein the dry crispness enhancing composition further comprises at least one additional component chosen from the group consisting of: a colorant; sodium chloride; a flavoring; a seasoning; and mixtures thereof;
wherein the whole vegetable is chosen from the group consisting of a fresh, unfrozen, uncut and unpeeled sweet potato and unfrozen, uncut and unpeeled fresh white potato; and
wherein the corn component sized to allow at least about 60% of the particles to be on and not pass through a US 70 mesh size screen (about 0.21 mm).

12. The method of claim 1, wherein the pregelatinized potato starch is a cross-linked and pregelatinized potato starch.

13. The method of claim 1, wherein the adhesion component consists of a pregelatinized potato starch as the only component configured to adhere to the corn component to the water enriched vegetable substrates.

14. The method of claim 1, wherein the adhesion component consists of a mixture of an uncross-linked pregelatinized potato starch and a cross-linked potato starch as the only component configured to adhere to the corn component to the water-enriched vegetable substrates.

15. The method of claim 1, wherein the pregelatinized potato starch comprises an uncross-linked pregelatinized potato starch and a cross-linked potato starch.

16. A method of producing a non-fried and non-parfried dusted vegetable product comprising the steps of:
providing a whole food substrate that is a whole vegetable. cutting the whole vegetable into a plurality of vegetable substrates;
contacting the plurality of vegetable substrates with water chosen from the group consisting of: tap water; distilled water; filtered water; or de-ionized water such that the plurality of vegetable substrates pick up at least about 3% water by weight of the plurality of vegetable substrates to form waterenriched vegetable substrates;
dusting the water-enriched vegetable substrates with a dry crispness enhancing composition configured to be dusted onto a surface of the water-enriched vegetable substrates to form dusted vegetable substrates wherein the dry crispness enhancing composition comprises a homogenous blend of (1) an adhesion component that consists of a pregelatinized potato starch and (2) a crisping particulate that comprises a corn component chosen from the group consisting of: a corn meal; a corn grit; and mixtures thereof; and
pre-baking the dusted vegetable substrates in a pre-baking oven to form prebaked vegetable substrates.

17. The method of claim 16, wherein the step of contacting the plurality of vegetable substrates with water to form water-enriched vegetable substrates causes the plurality of vegetable substrates to pick up about 3% to 12% water by weight of the plurality of vegetable substrates and the method further comprises the steps of:
freezing the pre-baked vegetable substrates to form frozen vegetable substrates;
transporting the frozen vegetable substrates to a consumer located at a different location than where the pre-baked vegetable substrates are formed; and
reconstituting by baking the frozen vegetable substrates in an oven to form reconstituted vegetable substrates.

18. A crisp, no added fat, non-parfried, non-fried, vegetable substrate comprising a baked vegetable substrate that, prior to baking, is a water-enriched vegetable substrate and is a portion of a whole vegetable wherein the baked vegetable substrate has a dry crispness enhancing composition on the surface of the vegetable substrate wherein the dry crispness enhancing composition comprises a homogeneous blend of a corn component chosen from the group consisting of a corn grit, a corn meal, or a mixture thereof and an adhesion composition that comprises a pregelatinized potato starch; wherein the vegetable substrate is not parfried or fried and has no added fat from any frying step and wherein the dry crispness enhancing composition increases the crispness of the vegetable substrate over an uncoated vegetable substrate that has been baked.

19. The crisp, no added fat, non-parfried, non-fried vegetable substrate of claim 18, wherein adhesion composition consists of a pregelatinized potato starch;
the dry crispness enhancing composition consists of the corn component; and
the adhesion composition is a dry dust or at least substantially free of water or other moisture or liquid component beyond any water present on an “as is” basis in the adhesion composition.

20. The crisp, no added fat, non-parfried, non-fried vegetable substrate of claim 18, wherein the adhesion composition is free of water or any other moisture or liquid component beyond any water present on an as is basis in the adhesion composition; and
wherein the corn component is free of water or any other moisture or liquid component beyond any water present on an as is basis in the corn composition.
